(19) United States
(12) Patent Application Publication
(10) Pub. No.: US 2019/0362661 A1
(43) Pub. Date: Nov. 28, 2019

(54) LIQUID CRYSTAL DISPLAY DEVICE

(71) Applicant: Mitsubishi Electric Corporation, Tokyo (JP)

(72) Inventor: Yoshiya SAITO, Tokyo (JP)

(73) Assignee: Mitsubishi Electric Corporation, Tokyo (JP)

(21) Appl. No.: 16/406,063

(22) Filed: May 8, 2019

(30) Foreign Application Priority Data
May 28, 2018 (JP) 2018-101412

(51) Int. Cl. G09G 3/00; G09G 3/36

(52) U.S. Cl. CPC G09G 3/006; G09G 3/3648

(57) ABSTRACT

An object is to provide a technique capable of detecting an abnormality of an output voltage value of a gate driver IC in a liquid crystal display device. A liquid crystal display device includes a liquid crystal panel 1, a gate driver IC 3a, and a gate driver IC 3b, and can take a first state and a second state. In the first state, an outN (N=1, 2, 3, . . . ) terminal in the gate driver IC 3a and an output unit 11 are connected and the gate driver IC 3a performs a voltage output operation, an outN (N=1, 2, 3, . . . ) terminal in the gate driver IC 3b and a detector 12 are connected and the gate driver IC 3b performs an abnormality detection operation, thus an abnormality of an output voltage value of the gate driver IC 3a is detected.

### BACKGROUND OF THE INVENTION

### Field of the Invention

The present invention relates to an abnormality detection of a liquid crystal display device, and particularly to a technique capable of detecting an abnormality in a voltage output operation of a gate driver IC for driving a liquid crystal.

### Description of the Background Art

A liquid crystal display device includes a gate driver IC driving a gate wiring for controlling ON and OFF of a thin film transistor (TFT) controlling a charging of a pixel and a source driver IC driving a source wiring for supplying a load to each pixel. Each driver IC operates for driving a liquid crystal panel in accordance with a control signal from a timing controller on a circuit substrate provided outside the liquid crystal panel.

The gate driver IC starts the operation upon receiving a vertical start pulse signal (STV1) from the timing controller, and outputs voltage to the gate wirings in synchronization with a shift clock (CLKV). At this time, the gate driver IC performs control so that on voltage of the TFT is output to one gate wiring and off voltage of the TFT is output to the remaining gate wirings. When a shift operation of all of the gate wirings is finished, the gate driver IC outputs a return signal (STV2) of the STV1. The output STV2 signal is monitored by the timing controller or a user, thus it can be confirmed whether the shift operation of the gate driver IC is normally performed.

For example, International Publication No 2015/125199 focuses on a wiring cascade-connecting a driver IC, and monitors a signal flowing in the wiring to detect an abnormality in the driver IC.

### SUMMARY

As described above, the abnormality of the shift operation of the gate driver IC can be detected by monitoring STV2 which is the return signal of STV1 of the gate driver IC, however, it cannot be determined whether each output voltage of the gate driver IC has a correct value. Thus, even when the value of the voltage being output from the gate driver IC is abnormal, STV2 is output from the gate driver IC as long as there is no problem in the shift operation, so that there is a problem that the timing controller or the user cannot detect the output abnormality of the date driver IC.

An object of the present invention is to provide a technique capable of detecting an abnormality of an output voltage value of a gate driver IC in a liquid crystal display device.

A liquid crystal display device according to the present invention includes a liquid crystal panel, a first gate driver IC, and a second gate driver IC. The liquid crystal panel has a plurality of gate wirings. The first gate driver IC has a plurality of first terminals, a first output unit, and a first detector. The second gate driver IC has a plurality of second terminals, a second output unit, and a second detector. The plurality of first terminals are connected to one ends of the plurality of gate wirings. The first output unit can be connected to the plurality of first terminals and performs a voltage output operation of outputting voltage for driving the plurality of gate wirings. The first detector can be connected to the plurality of first terminals and performs an abnormality detection operation of detecting an abnormality of a value of voltage supplied to the plurality of gate wirings. The plurality of second terminals are connected to the other ends of the plurality of gate wirings. The second output unit can be connected to the plurality of second terminals and performs a voltage output operation of outputting voltage for driving the plurality of gate wirings. The second detector can be connected to the plurality of second terminals and performs an abnormality detection operation of detecting an abnormality of a value of voltage supplied to the plurality of gate wirings. The liquid crystal display device can take a first state and a second state. In the first state, the plurality of the first terminals in the first gate driver IC and the first output unit are connected, the first gate driver IC performs the voltage output operation, the plurality of the second terminals in the second gate driver IC and the second detector are connected, and the second gate driver IC performs the abnormality detection operation, thus the abnormality of an output voltage value of the first gate driver IC is detected. In the second state, the plurality of the first terminals in the first gate driver IC and the first detector are connected, the first gate driver IC performs the abnormality detection operation, thereby detecting an abnormality of an output voltage value of the second gate driver IC, the plurality of the second terminals in the second gate driver IC and the second output unit are connected, and the second gate driver IC performs the voltage output operation.

The liquid crystal display device can detect whether the value of the voltage being output from the first terminal of the first gate driver IC is abnormal.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a liquid crystal display device according to an embodiment 1.

FIG. 2 is a schematic view showing a connection of a first gate driver IC, a second gate driver IC, and a timing controller included in the liquid crystal display device according to the embodiment 1.

FIG. 3 is an internal block diagram of the first gate driver IC and the second gate driver IC.

FIG. 4 is an internal block diagram of an output-detection switching unit.

FIG. 5 is an internal block diagram of a detector.

FIG. 6 is a configuration diagram of a VGH-VGL abnormality determination reference voltage generator.

FIG. 7 is a schematic view showing operations of the first gate driver IC and the second gate driver IC.

FIG. 8 is a schematic view showing a connection of a first gate driver IC, a second gate driver IC, and a timing controller included in a liquid crystal display device according to an embodiment 2 and operations thereof.

FIG. 9 is a schematic view showing a connection of a first gate driver IC, a second gate driver IC, and a timing controller included in a liquid crystal display device according to an embodiment 3 and operations thereof.

FIG. 10 is a schematic view showing a connection of a first gate driver IC, a second gate driver IC, and a timing controller included in a liquid crystal display device according to an embodiment 4 and operations thereof.

FIG. 11 is a schematic view of a liquid crystal display device according to a premise technique.

FIG. 12 is a timing chart showing an operation of a gate driver IC included in a liquid crystal display device according to the premise technique.

### DESCRIPTION OF THE PREFERRED EMBODIMENTS

<Premise Technique>

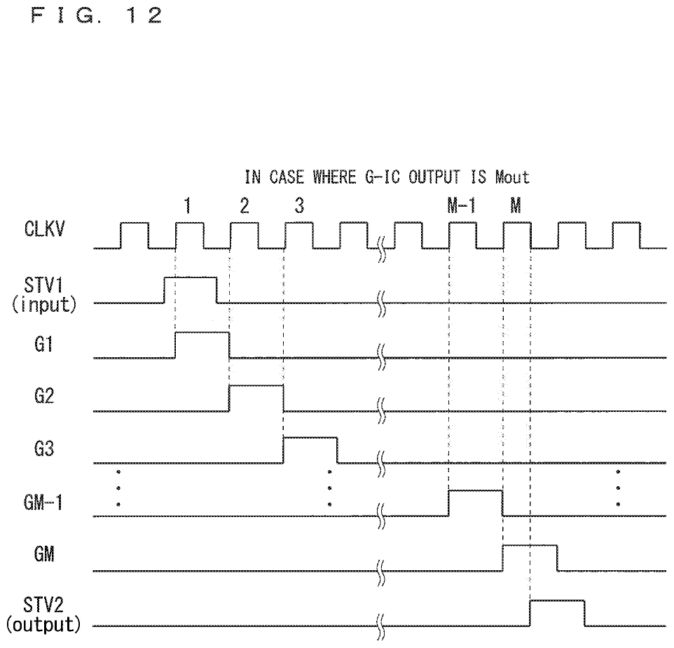

Firstly, a liquid crystal display device according to a premise technique is described. FIG. 11 is a schematic view of the liquid crystal display device according to the premise technique. FIG. 12 is a timing chart showing an operation of a gate driver IC 3 included in the liquid crystal display device according to the premise technique.

As illustrated in FIG. 11, the liquid crystal display device according to the premise technique includes a liquid crystal panel 1, a glass substrate 2, a gate driver IC 3, a source driver IC 4, a timing controller 7, and a circuit substrate 8. The liquid crystal panel 1 having a plurality of gate wirings 5 and a plurality of source wirings 6 is provided on an upper surface of the glass substrate 2.

The plurality of the gate wirings 5 and the plurality of the source wirings 6 are disposed to intersect with each other, and the gate driver IC 3 driving the plurality of the gate wirings 5 is connected to one ends of the plurality of the gate wirings 5. The source driver IC 4 driving the plurality of the source wirings 6 is connected to one ends of the plurality of the source wirings 6.

The gate driver IC 3 and the source driver IC 4 operate for driving the liquid crystal panel 1 in accordance with a control signal from the timing controller 7 on the circuit substrate 8 provided outside the liquid crystal panel 1.

As illustrated in FIG. 12, the gate driver IC 3 starts the operation upon receiving a vertical start pulse signal (STV1) from the timing controller 7, and outputs voltage to the gate wirings 5 in synchronization with a shift clock (CLKV). At this time, the gate driver IC 3 performs control so that on voltage of the TFT is output to one gate wiring 5 and off voltage of the TFT is output to the remaining gate wirings 5. When a shift operation of all of the gate wirings 5 is finished, the gate driver IC 3 outputs a return signal (STV2) of the STV1. The output STV2 signal is monitored by the timing controller 7, thus it can be confirmed whether the shift operation of the gate driver IC 3 is normally performed.

However, in the premise technique, the STV2 is output from the gate driver IC 3 as long as there is no problem in the shift operation even when the value of the voltage output from the gate driver IC 3 is abnormal, thus the premise technique has a problem that an output abnormality in the gate driver IC 3 cannot be detected. The liquid crystal display device according to an embodiment 1 solves the problem described above.

### Embodiment 1

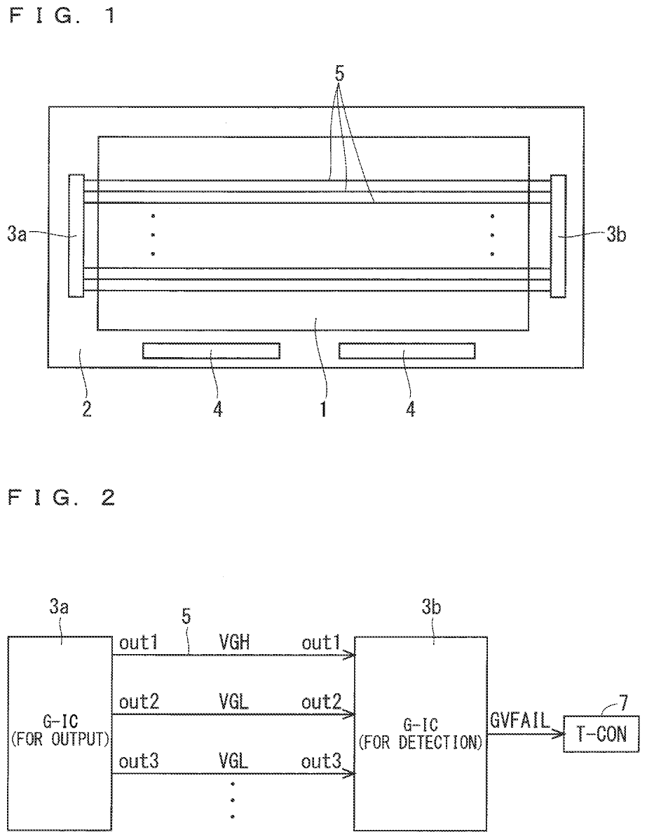

The embodiment 1 of the present invention is described hereinafter using the drawings. FIG. 1 is a schematic view of the liquid crystal display device according to the embodiment 1. FIG. 2 is a schematic view showing a connection of a gate driver IC 3a, a gate driver IC 3b, and a timing controller 7 included in the liquid crystal display device.

As illustrated in FIG. 1, the liquid crystal display device according to the embodiment 1 includes a liquid crystal panel 1, a glass substrate 2, the gate driver IC 3a as a first gate driver IC, a gate driver IC 3b as a second gate driver IC, a source driver IC 4 (refer to FIG. 11), the timing controller 7 (refer to FIG. 2), and a circuit substrate 8 (refer to FIG. 11). That is to say, the liquid crystal display device according to the embodiment 1 includes the gate driver IC 3a and the gate driver IC 3b in place of the gate driver IC 3 when compared to the liquid crystal display device according to the premise technique. The gate driver IC 3b may be the first gate driver IC, and the gate driver IC 3a may be the second gate driver IC.

The gate driver IC 3a is connected to one ends of the plurality of the gate wirings 5, and the gate driver IC 3b is connected to the other ends of the plurality of the gate wirings 5. In FIG. 1, the illustration of the source wirings 6, the timing controller 7, and the circuit substrate 8 is omitted. Although the number of the gate wirings 5 illustrated in FIG. 1 and FIG. 11 is different from each other, it is the same actually.

As illustrated in FIG. 2, the gate driver IC 3a includes an outN (N=1, 2, 3, . . . ) terminal as a first terminal. The gate driver IC 3b similarly includes an outN (N=1, 2, 3, . . . ) terminal as a second terminal. The outN (N=1, 2, 3, . . . ) terminal of the gate driver IC 3a is connected to one ends of the gate wiring 5 and the outN (N=1, 2, 3, . . . ) terminal of the gate driver IC 3b is connected to the other ends of the gate wiring 5. Herein, the outN (N=1, 2, 3, . . . ) terminals of the gate driver IC 3a and the gate driver IC 3b are bidirectional terminals.

In the embodiment 1, the gate driver IC 3a operates as a gate wiring drive IC performing a voltage output operation of outputting the voltage for driving the plurality of the gate wirings 5, that is to say, the on voltage (VGH) of the TFT or the off voltage (VGL) of the TFT in the manner similar to the gate driver IC 3 included in the liquid crystal display device according to the premise technique. In the meanwhile, the gate driver IC 3b detects the abnormality of the value of the voltage supplied to the gate wirings 5, thereby operating as an abnormality detection IC performing an abnormality detection operation of detecting the abnormality of the output voltage value of the gate driver IC 3a.

When the gate driver IC 3b determines that the detected voltage value of the VGH or VGL is abnormal, the gate driver IC 3b outputs an abnormal signal (GVFAIL). The timing controller 7 detects the GVFAIL signal, thus it can be recognized that the value of the voltage being output from the gate driver IC 3a is abnormal.

Both the gate driver IC 3a and the gate driver IC 3b can perform the voltage output operation and the abnormality detection operation. Accordingly, the liquid crystal display device can take a first state and a second state. In the first state, the gate driver IC 3a performs the voltage output operation, and the gate driver IC 3b performs the abnormality detection operation. In the second state, the gate driver IC 3a performs the abnormality detection operation, and the gate driver IC 3b performs the voltage output operation. In the embodiment 1, the liquid crystal display device takes the first state.

The gate driver IC 3a further includes a GDETMODE terminal as a first setting terminal which can perform a switching between the voltage output operation and the abnormality detection operation. In the same manner, the gate driver IC 3b further includes a GDETMODE terminal as a second setting terminal which can perform a switching between the voltage output operation and the abnormality detection operation. In the drawings, the gate driver IC is described as G-IC and the timing controller is described as T-CON.

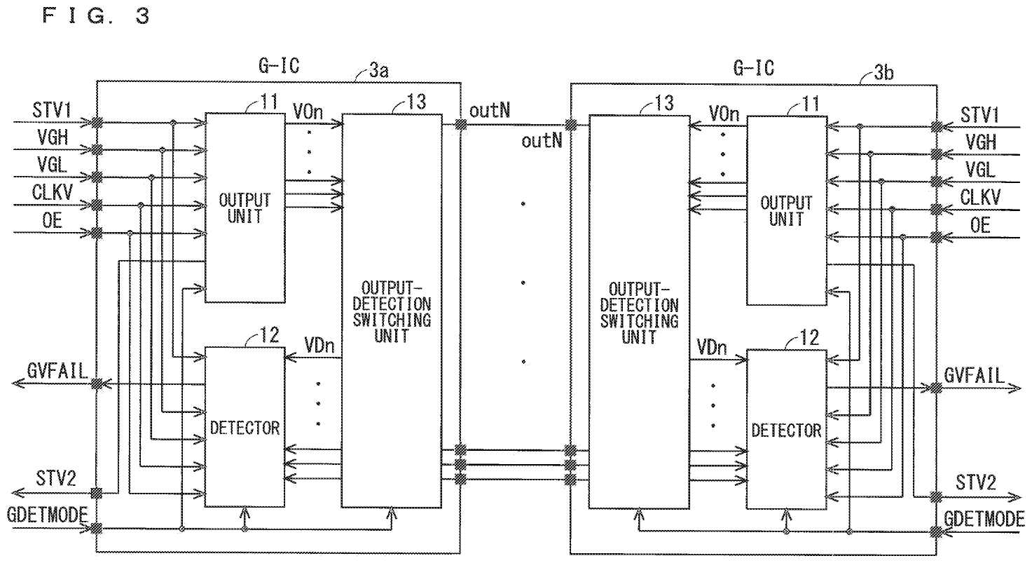

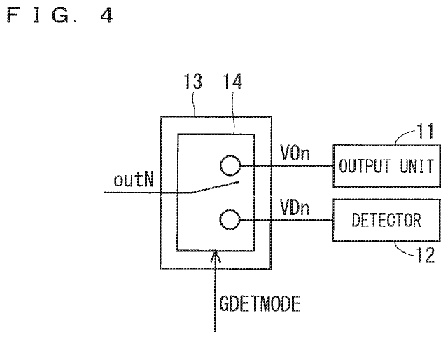

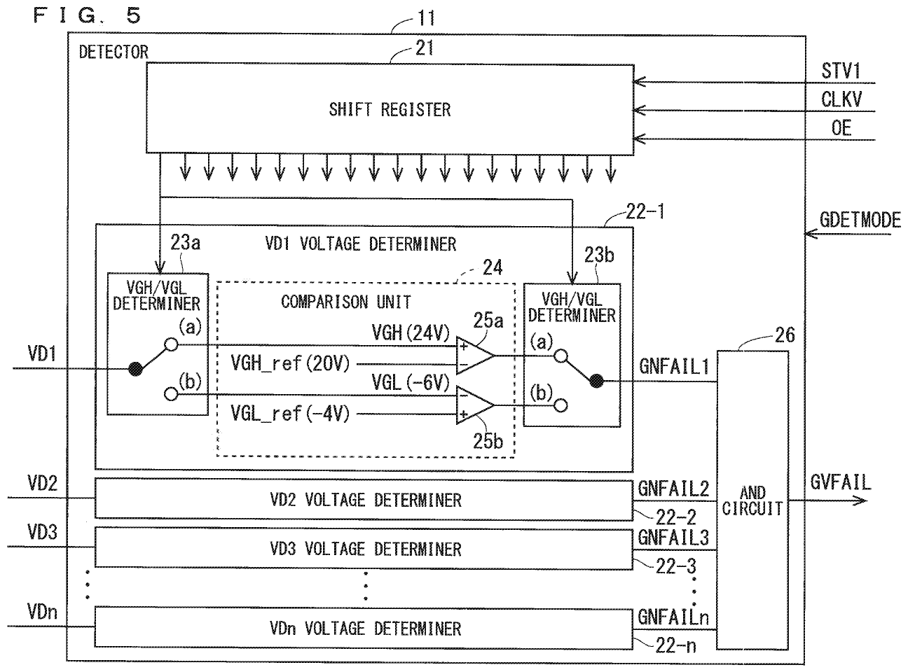

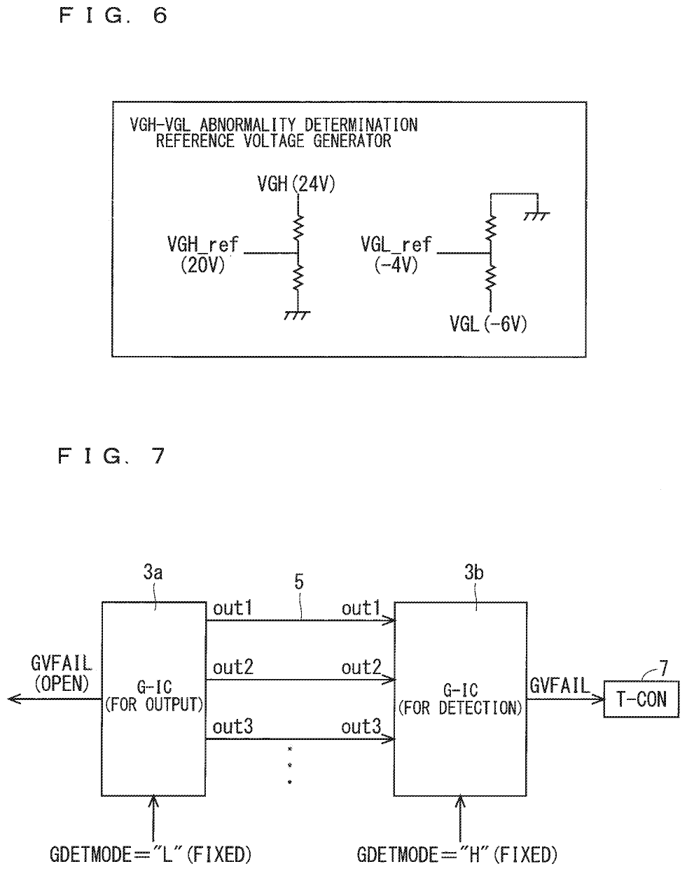

Next, the gate driver IC 3a and the gate driver IC 3b are described in detail. FIG. 3 is an internal block diagram of the gate driver IC 3a and the gate driver IC 3b, and internal blocks and input-output signals are illustrated in a simplified manner FIG. 4 is an internal block diagram of an output-detection switching unit 13. FIG. 5 is an internal block diagram of a detector 12. FIG. 6 is a configuration diagram of a VGH-VGL abnormality determination reference voltage generator. FIG. 7 is a schematic view showing operations of the gate driver IC 3a and the gate driver IC 3b.

As illustrated in FIG. 3, the gate driver IC 3a and the gate driver IC 3b include an output unit 11, a detector 12, and the output-detection switching unit 13. The output unit 11 of the gate driver IC 3a corresponds to a first output unit, and the detector 12 corresponds to a first detector. The output unit 11 of the gate driver IC 3b corresponds to a second output unit, and the detector 12 corresponds to a second detector.

As illustrated in FIG. 4, the output-detection switching unit 13 includes a switch 14, and selects whether the outN (N=1, 2, 3, . . . ) terminal is connected to a Von (n=1, 2, . . . ) terminal which is an output terminal of the output unit 11 or connected to a VDn (n=1, 2, . . . ) terminal which is an input terminal of the detector 12 in accordance with a signal being input to the GDETMODE terminal.

When the signal being input to the GDETMODE terminal is in “L” level, the outN (N=1, 2, 3, . . . ) terminal of the gate driver IC 3a is connected to the VOn (n=1, 2, . . . ) terminal of the output unit 11, and the gate driver IC 3a performs the voltage output operation. When the signal being input to the GDETMODE terminal is in “H” level, the outN (N=1, 2, 3, . . . ) terminal of the gate driver IC 3a is connected to the VDn (n=1, 2, . . . ) terminal of the detector 12, and the gate driver IC 3a performs the abnormality detection operation.

The output unit 11 constitutes a part in which a function itself of the gate driver IC 3 of the premise technique is included, starts the operation upon receiving the STV1, and outputs the VGH or VGL to the VOn (n=1, 2, . . . ) terminal in synchronization with the CLKV. When an output enable input signal (OE) is in “H” level, the output unit 11 sets the output of all of the VOn (n=1, 2, . . . ) terminals to the VGL asynchronously with the CLKV. When the signal being input to the GDETMODE terminal is in “H” level, the output unit 11 stops the voltage output operation, and the output of all of the VOn (n=1, 2, . . . ) terminals is opened.

Next, the detector 12 is described. As illustrated in FIG. 5, the detector 12 includes a shift register 21, a VD1 voltage determiner 22-1, a VD2 voltage determiner 22-2, a VD3 voltage determiner 22-3, . . . , a VDn voltage determiner 22-n, and an AND circuit 26. The detector 12 determines whether or not the value of each voltage (VGH or VGL) of the VDn (n=1, 2, . . . ) being input from the outN (N=1, 2, 3, . . . ) is normal, and detects the abnormality of the value of the voltage supplied to the plurality of the gate wirings 5.

Specifically, each voltage of the VDn (N=1, 2, . . . ) is input to the VD1 voltage determiner 22-1, the VD2 voltage determiner 22-2, the VD3 voltage determiner 22-3, . . . , and the VDn voltage determiner 22-n, respectively, and the abnormality determination is performed on each voltage in each block, and an abnormality determination signal GNFAILn (N=1, 2, . . . ) (“H” level in the normal state and “L” level in the abnormal state) is output. The abnormality determination signal GVFAIL which finally calculates AND in each GNFAILn (N=1, 2, . . . ) is output from the gate driver IC 3a and the gate driver IC 3b. When the input to the GDETMODE terminal is in “L” level, the detector 12 stops the abnormality detection operation, and the output of the GVFAIL terminal is opened.

The VD1 voltage determiner 22-1, the VD2 voltage determiner 22-2, the VD3 voltage determiner 22-3, . . . , and the VDn voltage determiner 22-n firstly determine which the VDn (N=1, 2, . . . ) determines, VGH or VGL, in accordance with the output from the shift register 21. After the STV1 is input, the shift register 21 determines whether the VDn (N=1, 2, . . . ) should determine the VGH (or VGL) by the shift operation performed by the CLKV, and transmits a command to the VD1 voltage determiner 22-1. At this time, when the OE signal is in “H” level, all of the VD1 voltage determiner 22-1, the VD2 voltage determiner 22-2, the VD3 voltage determiner 22-3, . . . , and the VDn voltage determiner 22-n performs a VGL determination asynchronously with the clock.

Next, VGH and VGL determination is described. The determination is performed in the VD1 voltage determiner 22-1, the VD2 voltage determiner 22-2, the VD3 voltage determiner 22-3, . . . , and the VDn voltage determiner 22-n, however, the determination performed in the VD1 voltage determiner 22-1 is described herein.

The VD1 voltage determiner 22-1 includes VGH/VGL determiners 23a and 23b and a omparison unit 24. The switch is switched to (a) when the VD1 voltage determiner 22-1 determines the VGH, and switched to (b) when the VD1 voltage determiner 22-1 determines the VGL. The comparison unit 24 includes two operational amplifiers 25a and 25b, and compares the VGH (or VGL) with a reference voltage VGH_ref (or VGL_ref), thus a level of the abnormal determination signal GNFAIL1 is determined in accordance with positive and negative of the amplifier output. Specifically, when the VGH falls below the VGH_ref, (or when the VGL exceeds the VGL_ref), the GNFAIL1 becomes “L” level. The voltage of VGH_ref and VGL_ref is generated in a circuit illustrated in FIG. 6.

As illustrated in FIG. 7, the input of the gate driver IC 3a to the GDETMODE terminal is fixed to “L” level, and the input of the gate driver IC 3b to the GDETMODE terminal is fixed to “H” level, thus the gate driver IC 3a performs the voltage output operation, and the gate driver IC 3b performs the abnormality detection operation. Then, the CVFAIL signal from the gate driver IC 3b is monitored by the timing controller 7, thus the abnormality of the gate voltage can be detected.

As described above, the liquid crystal display device according to the embodiment 1 can take the first state and the second state. In the first state, the outN (N=1, 2, 3 . . . ) terminal in the gate driver IC 3a and the output unit 11 are connected and the gate driver IC 3a performs the voltage output operation, and the outN (N=1, 2, 3 . . . ) terminal in the gate driver IC 3b and detector 12 are connected and the gate driver IC 3b performs the abnormality detection operation. Thus, the abnormality of the output voltage value of the gate driver IC 3a is detected. Accordingly, the liquid crystal display device can detect whether the value of the voltage being output from the outN (N=1, 2, 3, . . . ) terminal of the gate driver IC 3a is abnormal.

According to this configuration, a detection ratio of a failure in the gate driver IC 3a and a disconnecting in the gate wirings 5 on the liquid crystal panel 1 can be improved.

The gate driver IC 3a and the gate driver IC 3b further have the GDETMODE terminal which can perform a switching between the voltage output operation and the abnormality detection operation by switching the connection between the outN (N=1, 2, 3 . . . ) terminal and the output unit 11 and the connection between the outN (N=1, 2, 3 . . . ) terminal the detector 12. Accordingly, the voltage output operation and the abnormality detection operation can be switched with one type of gate driver IC, thus a general versatility of the gate driver IC is improved.

### Embodiment 2

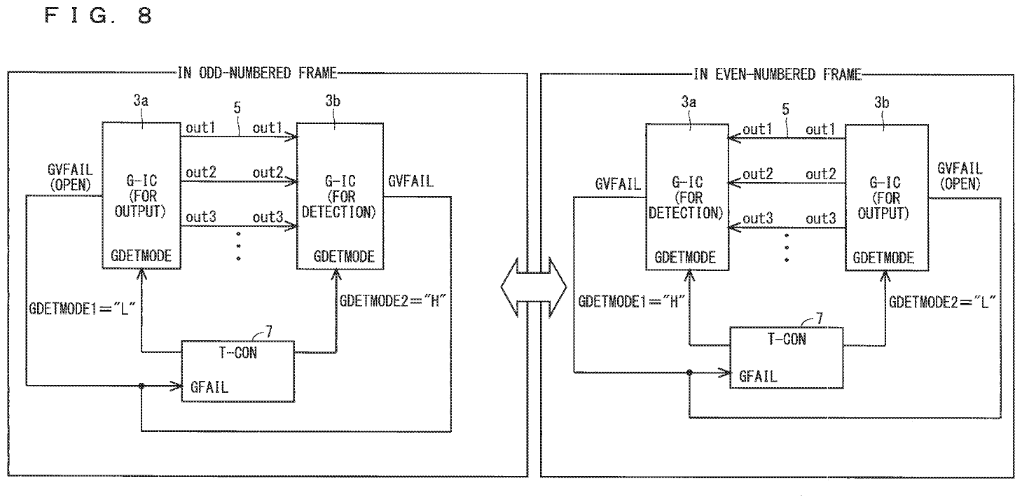

Next, a liquid crystal display device according to the embodiment 2 is described. FIG. 8 is a schematic view showing a connection of a gate driver IC 3a, a gate driver IC 3b, and a timing controller 7 included in the liquid crystal display device according to the embodiment 2 and operations thereof. In the embodiment 2, the same reference numerals as those described in the embodiment 1 will be assigned to the same constituent element and the description thereof will be omitted.

In the embodiment 2, as illustrated in FIG. 8, the GDETMODE terminals of the gate driver IC 3a and the gate driver IC 3b and a GDETMODE1 terminal and GDETMODE2 terminal of the timing controller 7 are connected to each other, respectively. “H/L” levels of the signals being output from the GDETMODE1 terminal and the GDETMODE2 terminal are controlled so that they are different from each other.

Specifically, the timing controller 7 inverts the “H/L” levels of the signals being output from the GDETMODE1 terminal and the GDETMODE2 terminal for each frame of a video signal. Accordingly, the gate driver IC 3a and the gate driver IC 3b can perform control for switching the voltage output operation and the abnormality detection operation alternately for each frame of the video signal.

In the embodiment 1, the abnormality of the output voltage value of only one gate driver IC 3a can be detected, however, in the embodiment 2, the abnormality of the output voltage values of both the gate driver IC 3a and the gate driver IC 3b can be detected.

For example, the timing controller 7 outputs the signal of “L” level from the GDETMODE1 terminal in an odd-numbered frame, and outputs the signal of “H” level from the GDETMODE2 terminal, thus the gate driver IC 3a performs the voltage output operation, and the gate driver IC 3b performs the abnormality detection operation. The timing controller 7 outputs the signal of “H” level from the GDETMODE1 terminal in an even-numbered frame, and outputs the signal of “L” level from the GDETMODE2 terminal, thus the gate driver IC 3a performs the abnormality detection operation, and the gate driver IC 3b performs the voltage output operation.

As described above, in the liquid crystal display device according to the embodiment 2, the gate driver IC 3a and the gate driver IC 3b perform the switching between the voltage output operation and the abnormality detection operation alternately for each frame of the video signal. Accordingly, the abnormality of all of the output voltage values of both the gate driver IC 3a and the gate driver IC 3b can be detected.

The switching signal for performing the switching between the voltage output operation and the abnormality detection operation in the gate driver IC 3a and the gate driver IC 3b can be easily generated by the timing controller 7, thus the switching between the voltage output operation and the abnormality detection operation can be easily controlled by the timing controller 7.

### Embodiment 3

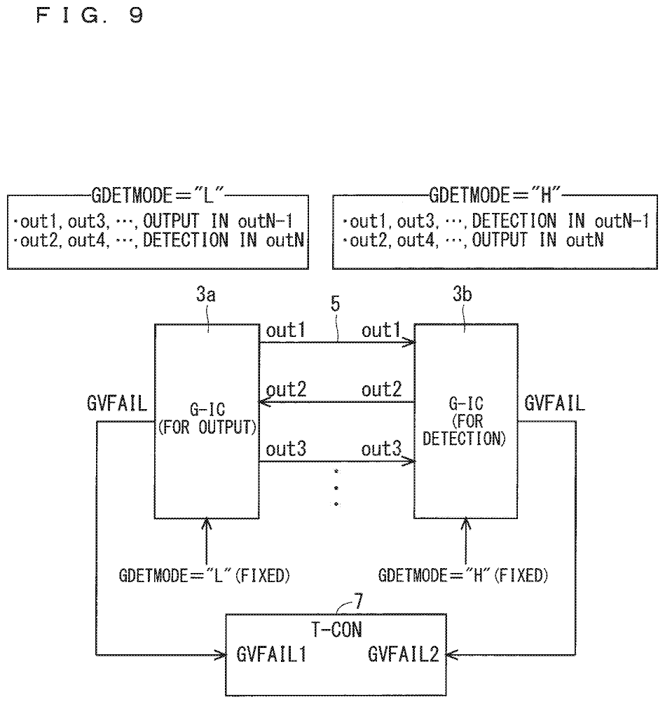

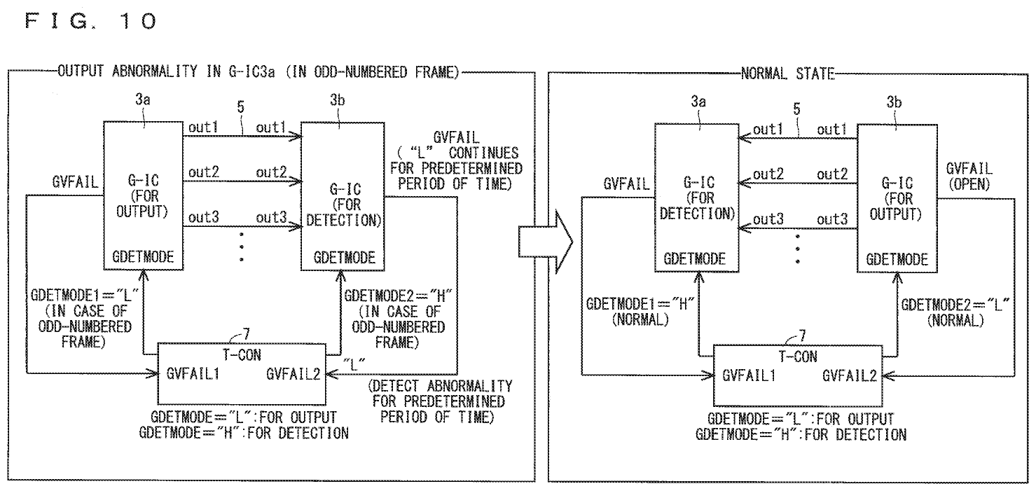

Next, a liquid crystal display device according to the embodiment 3 is described. FIG. 9 is a schematic view showing a connection of a gate driver IC 3a, a gate driver IC 3b, and a timing controller 7 included in the liquid crystal display device according to the embodiment 3 and operations thereof. In the embodiment 3, the same reference numerals as those described in the embodiments 1 and 2 will be assigned to the same constituent element and the description thereof will be omitted.

In the embodiment 3, as illustrated in FIG. 9, the gate driver IC 3a performs the voltage output operation in the outN (N=1, 2, 3 . . . ) terminal connected to at least one of the gate wirings 5 in the plurality of the gate wirings 5, and performs the abnormality detection operation in the outN (N=1, 2, 3 . . . ) terminal connected to the remaining gate wirings 5 in the plurality of the gate wirings 5, thereby detecting the abnormality of the output voltage value of the gate driver IC 3b.

The gate driver IC 3b performs the abnormality detection operation in the outN (N=1, 2, 3 . . . ) terminal connected to a portion of the gate wirings 5 in the plurality of the gate wirings 5, thereby detecting the abnormality of the output voltage value of the gate driver IC 3a, and performs the voltage output operation in the outN (N=1, 2, 3 . . . ) terminal connected to the remaining gate wirings 5 in the plurality of the gate wirings 5.

In the embodiment 1, the abnormality of the output voltage value of only one gate driver IC 3a can be detected, however, in the embodiment 3, the abnormality of the output voltage values of both the gate driver IC 3a and the gate driver IC 3b can be detected in the manner similar to the embodiment 2.

The gate driver IC 3a and the gate driver IC 3b included in the liquid crystal display device according to the embodiment 3 has a specification altered based on the configuration illustrated in FIG. 3. Since the signal of “L” level is input to the GDETMODE terminal of the gate driver IC 3a in the fixed state, the gate driver IC 3a performs the voltage output operation in an odd-numbered terminal in the outN (N=1, 2, 3 . . . ) terminal, and performs the abnormality detection operation in an even-numbered terminal. Furthermore, since the signal of “H” level is input to the GDETMODE terminal of the gate driver IC 3b in the fixed state, the gate driver IC 3b performs the abnormality detection operation in the odd-numbered terminal, and performs the voltage output operation in the even-numbered terminal.

At this time, provided in the timing controller 7 are a GVFAIL1 terminal monitoring the GVFAIL being output from the gate driver IC 3a and a GVFAIL2 terminal monitoring the GVFAIL being output from the gate driver IC 3b. Accordingly, the GVFAIL signals from the gate driver IC 3a the gate driver IC 3b are monitored by the timing controller 7, thus the abnormality of the gate voltage can be detected.

As described above, in the liquid crystal display device according to the embodiment 3, the gate driver IC 3a performs the voltage output operation in the outN (N=1, 2, 3 . . . ) terminal connected to a portion of the gate wirings 5 in the plurality of the gate wirings 5, and performs the abnormality detection operation in the outN (N=1, 2, 3 . . . ) terminal connected to the remaining gate wirings 5 in the plurality of the gate wirings 5, thereby detecting the abnormality of the output voltage value of the gate driver IC 3b. The gate driver IC 3b performs the abnormality detection operation in the outN (N=1, 2, 3 . . . ) terminal connected to at least one of the gate wirings 5 in the plurality of the gate wirings 5, thereby detecting the abnormality of the output voltage value of the gate driver IC 3a, and performs the voltage output operation in the outN (N=1, 2, 3 . . . ) terminal connected to the remaining gate wirings 5 in the plurality of the gate wirings 5.

Accordingly, the abnormality of the output voltage values of both the gate driver IC 3a and the gate driver IC 3b can be simultaneously detected. Since the signals being input to the GDETMODE terminal of the gate driver IC 3a and the gate driver IC 3b are fixed to “L” level and “H” level, respectively, the control can be easily performed without depending on the control from outside.

Furthermore, when the switching is performed so that the voltage output operation and the abnormality detection operation are alternately switched for each frame as is the case in the embodiment 2, there is a possibility that the abnormality in one gate driver IC cannot be detected depending on the timing, however, in the embodiment 3, the timing controller 7 can continuously monitor the GVFAIL signals of both the gate driver IC 3a and the gate driver IC 3b without depending on the time.

### Embodiment 4

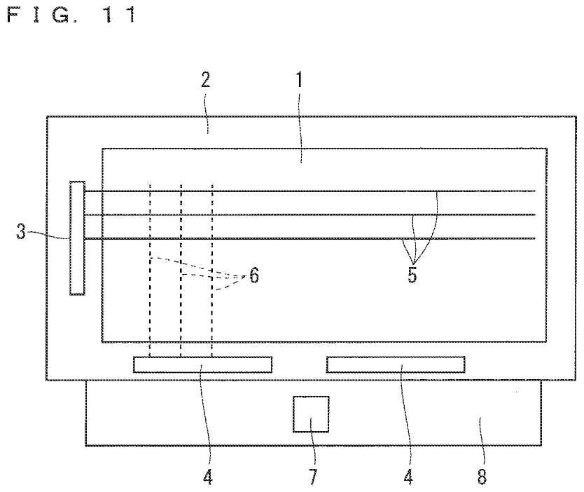

Next, a liquid crystal display device according to the embodiment 4 is described. FIG. 10 is a schematic view showing a connection of a gate driver IC 3a, a gate driver IC 3b, and a timing controller 7 included in the liquid crystal display device according to the embodiment 4 and operations thereof. In the embodiment 4, the same reference numerals as those described in the embodiments 1 to 3 will be assigned to the same constituent element and the description thereof will be omitted.

In the embodiment 4, as illustrated in FIG. 10, the gate driver IC 3a is controlled so that only the gate driver IC 3a performs the voltage output operation when it detects the abnormality of the output voltage value of the gate driver IC 3b for a certain period of time. The gate driver IC 3b is controlled so that only the gate driver IC 3b performs the voltage output operation when it detects the abnormality of the output voltage value of the gate driver IC 3a for a certain period of time.

As is the case in the embodiment 3, provided in the timing controller 7 are a GVFAIL1 terminal monitoring the GVFAIL being output from the gate driver IC 3a and a GVFAIL2 terminal monitoring the GVFAIL being output from the gate driver IC 3b.

As is the case in the embodiment 2, the gate driver IC 3a and the gate driver IC 3b are controlled so that they perform the switching between the voltage output operation and the abnormality detection operation alternately for each frame of the video signal. When the timing controller 7 determines that the state of “L” level continues for a certain period of time in the GVFAIL2 terminal, that is to say, when the gate driver IC 3b detects the abnormality of the output voltage value of the gate driver IC 3a for a certain period of time, the timing controller 7 outputs the signal being output from the GDETMODE1 terminal in “H” level constantly, and outputs the signal being output from the GDETNMODE2 terminal in “L” level constantly. Accordingly, the gate driver IC 3a can constantly perform the abnormality detection operation, and the gate driver IC 3b can constantly perform the voltage output operation.

In the meanwhile, when the timing controller 7 determines that the state of “L” level continues for a certain period of time in the GVFAIL1 terminal, that is to say, when the gate driver IC 3a detects the abnormality of the output voltage value of the gate driver IC 3b for a certain period of time, the timing controller 7 outputs the signal being output from the GDETMODE1 terminal in “L” level constantly, and outputs the signal being output from the GDETNMODE2 terminal in “H” level constantly. Accordingly, the gate driver IC 3a can constantly perform the voltage output operation, and the gate driver IC 3b can constantly perform the abnormality detection operation.

As described above, in the liquid crystal display device according to the embodiment 4, only the gate driver IC 3a can perform the voltage output operation when it detects the abnormality of the output voltage value of the gate driver IC 3b for a certain period of time. Only the gate driver IC 3b can perform the voltage output operation when it detects the abnormality of the output voltage value of the gate driver IC 3a for a certain period of time. Accordingly, the gate driver IC having the abnormality in the voltage output operation can be automatically excluded from the one performing the voltage output operation.

According to the present invention, the above embodiments can be arbitrarily combined, or each embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device, comprising:
a liquid crystal panel having a plurality of gate wirings;
a first gate driver IC having a plurality of first terminals connected to one ends of the plurality of the gate wirings, a first output unit connectable to the plurality of the first terminals and performing a voltage output operation of outputting voltage for driving the plurality of the gate wirings, and a first detector connectable to the plurality of the first terminals and performing an abnormality detection operation of detecting an abnormality of a value of the voltage supplied to the plurality of the gate wirings; and
a second gate driver IC having a plurality of second terminals connected to another one of ends of the plurality of the gate wirings, a second output unit connectable to the plurality of the second terminals and performing a voltage output operation of outputting voltage for driving the plurality of the gate wirings, and a second detector connectable to the plurality of the second terminals and performing an abnormality detection operation of detecting an abnormality of a value of the voltage supplied to the plurality of the gate wirings, wherein
the liquid crystal display device can take a first state and a second state,
in the first state, the plurality of the first terminals in the first gate driver IC and the first output unit are connected, the first gate driver IC performs the voltage output operation, the plurality of the second terminals in the second gate driver IC and the second detector are connected, and the second gate driver IC performs the abnormality detection operation, thus an abnormality of an output voltage value of the first gate driver IC is detected, and
in the second state, the plurality of the first terminals in the first gate driver IC and the first detector are connected, the first gate driver IC performs the abnormality detection operation, thereby detecting an abnormality of an output voltage value of the second gate driver IC, the plurality of the second terminals in the second gate driver IC and the second output unit are connected, and the second gate driver IC performs the voltage output operation.

2. The liquid crystal display device according to claim 1, wherein
the first gate driver IC further has a first setting terminal performing a switching between a connection of the plurality of the first terminals to the first output unit and a connection of the plurality of the first terminals to the first detector, thereby enabling a switching between the voltage output operation and the abnormality detection operation, and
the second gate driver IC further has a second setting terminal performing a switching between a connection of the plurality of the second terminals to the second output unit and a connection of the plurality of the second terminals to the second detector, thereby enabling a switching between the voltage output operation and the abnormality detection operation.

3. The liquid crystal display device according to claim 2, wherein
the first gate driver IC and the second gate driver IC performs a switching so that the voltage output operation and the abnormality detection operation are alternately switched for each frame of a video signal.

4. The liquid crystal display device according to claim 2, wherein
the first gate driver IC performs the voltage output operation in the first terminal connected to a portion of the gate wirings in the plurality of the gate wirings, and performs the abnormality detection operation in the first terminal connected to a remainder of the gate wirings in the plurality of the gate wirings, thereby detecting an abnormality of an output voltage value of the second gate driver IC, and
the second gate driver IC performs the abnormality detection operation in the second terminal connected to the portion of the gate wirings in the plurality of the gate wirings, thereby detecting an abnormality of an output voltage value of the first gate driver IC, and performs the voltage output operation in the second terminal connected to the remainder of the gate wirings in the plurality of the gate wirings.

5. The liquid crystal display device according to claim 3, wherein
only the first gate driver IC can perform the voltage output operation when the first gate driver IC detects an abnormality of an output voltage value of the second gate driver IC for a predetermined period of time.
